(19) United States
(12) Patent Application Publication
(10) Pub. No.: US 2016/0016124 A1
(43) Pub. Date: Jan. 21, 2016

(54) Fluoropolymer Article for Mycoplasma Filtration

(71) Applicant: W.L. Gore & Associates, Inc., Newark, DE (US)

(72) Inventors: Lei Zheng, Newark, DE (US); Michael J. Wikol, Landenberg, PA (US); Jason J. Strid, Elkton, MD (US)

(21) Appl. No.: 14/753,479

(22) Filed: Jun. 29, 2015

Related U.S. Application Data
(63) Continuation-in-part of application No. 14/336,031, filed on Jul. 21, 2014.

(51) Int. Cl. B01D 69/12; B01D 71/36

(52) U.S. Cl. CPC B01D 69/12; B01D 71/36; B01D 2325/36; B01D 2325/04; B01D 2325/20

(57) ABSTRACT

A mycoplasma retentive filter having an LRV greater than 8 including at least two mycoplasma non-retentive fluoropolymer membranes positioned in a stacked configuration is provided. The fluoropolymer membranes a bubble point from about 30 psi to about 90 psi, a thickness less than about 10 microns, and a mass/area less than about 10 g/m². The mycoplasma non-retentive fluoropolymer membranes are is separated from each other by a distance d, which may be less than about 100 microns. The fluoropolymer membranes may be laminated or co-expanded to produce a composite stacked filtration material. In exemplary embodiments, at least one of the fluoropolymer membranes is an expanded polytetrafluoroethylene membrane. In one embodiment, the surface morphology of the fluoropolymer membranes are substantially the same and contain no or substantially no free fibrils. Methods of producing a sterilizing grade filter are also provided.

### FIELD

The present disclosure relates generally to bacterial filtration, and more specifically, to a multilayered filtration article that is mycoplasma retentive while simultaneously offering significant improvement in flow rate.

### BACKGROUND

Bacterial contamination poses a threat to the safety of biopharmaceuticals, and food and beverage streams. To that end, filters have been developed to provide removal of bacteria from such process streams. Known filters that provide bacterial filtration typically employ one or more membranes. Some such filters build in a safety net and employ two layers of membranes to provide sterility assurance. That is, even if there is some passage of bacteria through the first membrane layer, the presence of the second membrane layer will presumably retain any bacteria that was not retained in the first layer. However, the flow rate of a filter is often significantly lowered with such a dual layered configuration.

In order to improve flow rate, attempts were made to use thinner membranes. As membranes become thinner, the probability to have oversized pores (i.e. pores larger than the size of bacteria) increased significantly. This makes the thin membrane unfit for biopharmaceutical filtration, where higher retention efficiency is required. One approach to solve this problem was to use membranes with small pore sizes (high bubble point) to reduce the probability of these oversized pores. Although membranes with high bubble points (or small pore size) may have effective bacterial retention, they tend to suffer from low capacity for throughput). Additionally, their flow rate per unit area is highly compromised and the ability to correlate bubble point and thickness to bacterial retention is lowered due to small amount of oversized pores.

As it is desirable to improve the flow rate per unit area of filtration without compromising bacterial retention characteristics, there remains a need for a thin porous membrane (i.e. less than about 10 microns) which provides high flow rate per unit area while simultaneously being mycoplasma retentive.

### SUMMARY

One embodiment of the invention relates to a stacked bacterial filter material that includes (1) a first mycoplasma non-retentive fluoropolymer membrane having a first major surface and a second major surface and (2) a second mycoplasma non-retentive fluoropolymer membrane positioned on the first or second major surface a distance d from the first fluoropolymer membrane. The distance d may be less than 100 microns. The first and second fluoropolymer membranes each have a bubble point from about 30 psi to about 90 psi and a thickness less than about 10 microns. The first and second fluoropolymer membranes may also have a mass/area from about 0.1 g/m² to about 2 g/m². Additionally, the first and second major surfaces are substantially free of free fibrils. In one or more embodiment, at least one of the first and second fluoropolymer membranes is an expanded polytetrafluoroethylene (ePTFE) membrane. Additionally, the stacked bacterial filtration material is a mycoplasma retentive filter and has an LRV greater than 8.

A second embodiment of the invention relates to a bacterial filtration material that includes (1) a stacked filter material and (2) a first fibrous layer positioned on the stacked filter material. The bacterial filtration material is mycoplasma retentive. The bacterial filtration material has an LRV greater than 8. The stacked filter material includes (1) a first mycoplasma non-retentive fluoropolymer membrane having a first major surface and a second major surface and (2) a second mycoplasma non-retentive fluoropolymer membrane positioned on the first major surface a distance from the first major surface. The distance d may be less than 100 microns. In addition, the first and second fluoropolymer membranes each have a bubble point from about 30 psi to about 90 psi and a thickness less than about 10 microns. In an exemplary embodiment, at least one of the first and second fluoropolymer membranes is an expanded polytetrafluoroethylene. The first and second fluoropolymer membranes may be derived from a parent fluoropolymer membrane divided in a direction perpendicular to a length direction of the parent fluoropolymer membrane. In at least one embodiment, a second fibrous layer is positioned on the stacked filter material on a side opposing the first fibrous layer.

A third embodiment of the invention relates to a bacterial filtration material that includes (1) a stacked filter material and (2) a first fibrous layer positioned on the stacked filter material. The stacked filter material includes (1) a first mycoplasma non-retentive fluoropolymer membrane having a first major surface and a second major surface and (2) a second mycoplasma non-retentive fluoropolymer membrane positioned on the first major surface a distance from the first major surface. The distance d may be less than 100 microns. Additionally, the first and second fluoropolymer membranes may be derived from a parent fluoropolymer membrane divided in a direction perpendicular to a length direction of the parent fluoropolymer membrane. In addition, the first and second fluoropolymer membranes each have a bubble point from about 30 psi to about 90 psi, a thickness less than about 10 microns, and a mass/area from about 0.1 g/m² to about 2 g/m². The bacterial filtration material is a mycoplasma retentive filter and has an LRV greater than 8.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 a schematic illustration of layers of material within a filtration material according to at least one embodiment of the invention;

FIG. 2 is a schematic illustration of the orientation of materials within the stacked filter material according to at least one embodiment of the invention;

FIG. 3 is an exploded view of a filtration device containing a pleated filtration medium in accordance with an embodiment of the present invention;

FIG. 4 is a scanning electron micrograph of the top surface of an ePTFE membrane for use in a stacked filter taken at 5000× in accordance with one embodiment of the invention

FIG. 5 is a scanning electron micrograph of the bottom surface of the ePTFE membrane of FIG. 4 taken at 5000× according to one embodiment of the invention;

FIG. 6 is a scanning electron micrograph of a cross-section of the ePTFE membrane of FIG. 4 taken at 10,000× in accordance with another embodiment of the invention:

FIG. 7 is a scanning electron micrograph of the top surface of an ePTFE membrane for use in a stacked filter taken at 5000× in accordance with one embodiment of the invention;

FIG. 8 is a scanning electron of the bottom surface of the ePTFE membrane of FIG. 7 taken at 5000× according to another embodiment of the invention;

FIG. 9 is a scanning electron micrograph of a cross-section of the ePTFE membrane of FIG. 7 taken at 10,000× in accordance with another embodiment of the invention; and

FIG. 10 is a schematic illustration of a stacked filter material containing three fluoropolymer membranes according to at least one embodiment of the invention.

### GLOSSARY

The term “mycoplasma retentive” as used herein is meant to define a filtration material that has a Log Retention Value (LRV) greater than 8 when tested according to the procedure set forth in the Mycoplasma Retention Test Method described herein.

As used herein, the term “thickness dimension” is the direction of the membrane orthogonal or substantially orthogonal to the length of the membrane.

As used herein, the term “length dimension” is the direction of the membrane orthogonal or substantially orthogonal to the thickness of the membrane.

As used herein, the term “major surface” is meant to describe the top and/or bottom surface along the length of the membrane and is perpendicular to the thickness of the membrane.

The term “fibrous layer” as used herein is meant to describe a cohesive structure of fibers which may be a woven structure, a nonwoven structure, or a knit structure.

As used herein, the term “on” is meant to denote an element, such as an expanded polytetrafluoroethylene (ePTFE) membrane, is directly on another element or intervening elements may also be present.

As used herein, the term “adjacent” is meant to denote an element, such as an ePTFE membrane, is directly adjacent to another element or intervening elements may also be present.

The term “substantially zero microns” is meant to define a distance that is less than or equal to 0.1 microns.

As used herein, the term “free fibrils” is meant to describe fibrils that have two ends, one end is connected to the surface of the membrane and the second end is not connected to the surface of the membrane and extends away or outwardly from the surface of the membrane.

The term “nanofiber” as used herein is meant to describe a fiber having a diameter of several nanometers up to about thousands of nanometers.

As used herein, the phrase “distance between contiguous fluoropolymer membranes” is meant to define the distance between two fluoropolymer membranes that are positioned next to each other in a stacked configuration with no intervening elements or membranes therebetween.

### DETAILED DESCRIPTION

Persons skilled in the art will readily appreciate that various aspects of the present disclosure can be realized by any number of methods and apparatus configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

The present invention is directed to mycoplasma non-retentive fluoropolymer membranes that, when placed in a stacked or layered orientation, are able to filter mycoplasma with a Log Retention Value (LRV) greater than 8 with improved flow rates. Individually, however, the fluoropolymer membranes are mycoplasma nonretentive (e.g., have an LRV less than 8) and allow some mycoplasma to pass through. The fluoropolymer membrane(s) may be an expanded polytetrafluoroethylene (ePTFE) membrane that has a bubble point from about 30 psi to about 90 psi, a thickness less than about 10 microns, and a mass/area less than about 10 g/m².

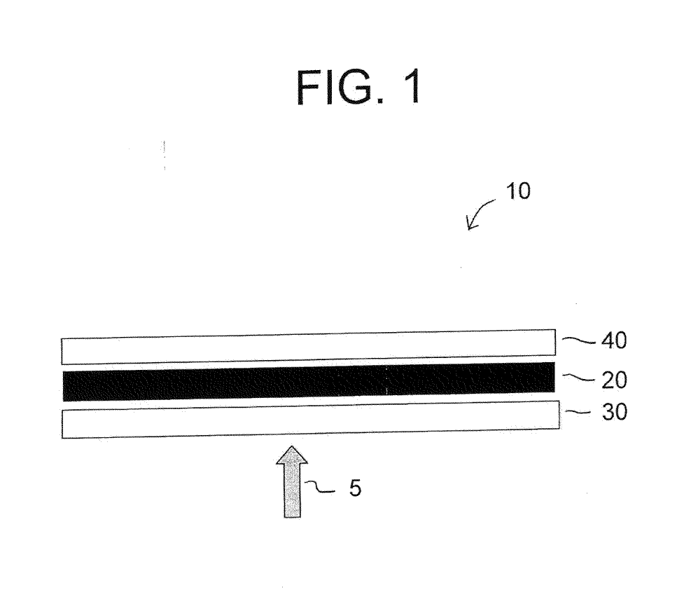

The mycoplasma filtration material includes at least a first layer of a stacked filter material and at least one fibrous layer that is configured to support the stacked filter material and/or is configured to provide drainage of fluid away from the stacked filter material. FIG. 1 depicts one exemplary orientation of the layers of materials forming the bacterial filtration material 10. As shown, the filtration medium 10 may include a stacked filter material 20, a first fibrous layer 30 forming an upstream drainage layer and an optional second fibrous layer 40 forming a downstream drainage layer. The arrow 5 depicts the direction of fluid flow through the filtration material.

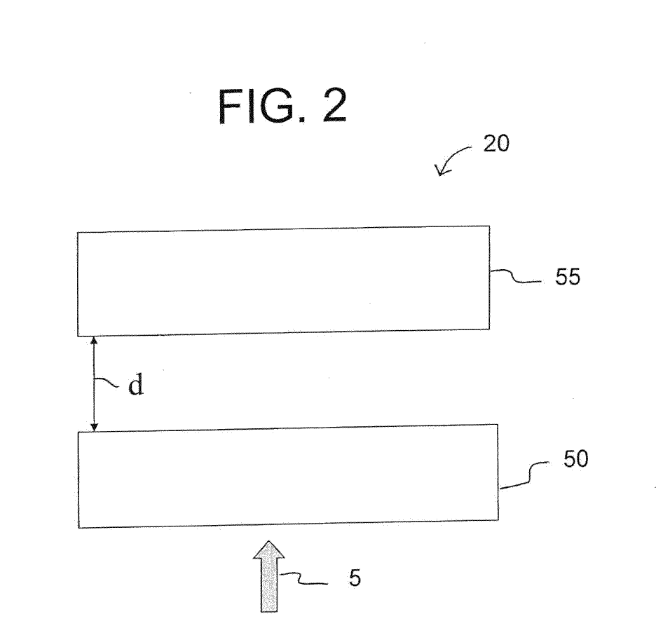

The stacked filter material 20 contains two fluoropolymer membranes 50, 55 positioned in a stacked or layered configuration as shown generally in FIG. 2. The fluoropolymer membrane 50 is positioned adjacent to or on the fluoropolymer membrane 55 such that material flows through the membranes 50, 55 (illustrated by arrow 5). Additionally, fluoropolymer membrane 50 is separated from fluoropolymer membrane 55 by a distance d. The distance d is the distance between contiguous fluoropolymer membranes (e.g., membranes 50, 55). As used herein, the phrase “distance between contiguous fluoropolymer membranes” is meant to define the distance between two fluoropolymer membranes that are positioned next to each other in a stacked configuration with no intervening elements or membranes therebetween. The distance d may range from about 0 microns to about 100 microns, from about 0 microns to about 75 microns, from about 0 microns to about 50 microns, or from about 0 microns to about 25 microns. In some embodiments, the distance d is zero or substantially zero microns. The distance may also be less than about 100 microns, less than about 75 microns, less than about 50 microns, less than about 25 microns, less than about 20 microns, less than about 15 microns, less than about 10 microns, less than about 5 microns, or less than about 1 micron.

The fluoropolymer membranes 50, 55 may be positioned in a stacked configuration by simply laying the membranes on top of each other. Alternatively, the fluoropolymer membranes may be stacked and subsequently laminated together using heat and/or pressure. Embodiments employing two fluoropolymer membranes that are co-expanded to produce a composite stacked filtration material is also considered to be within the purview of the invention. The composite stacked filtration material may contain two or more layers of fluoropolymer membranes that may be co-extruded or integrated together. In such an embodiment, the first fluoropolymer membrane and second fluoropolymer membrane are in a stacked configuration, but the distance between the first and second fluoropolymer membranes is zero or nearly zero. The composite stacked filtration material has a first major surface and a second major surface. Such a composite stacked filtration material may have a bubble point from about 30 psi to about 90 psi, from about 35 psi to about 90 psi, from about 50 psi to about 90 psi, from about 50 psi to about 65 psi, or from about 70 psi to about 80 psi. Alternatively, the composite stacked filtration material may have a bubble point less than about 90 psi, less than about 70 psi, less than about 50 psi, or less than about 45 psi. Additionally the first and second major surfaces are free or substantially free of fibrils.

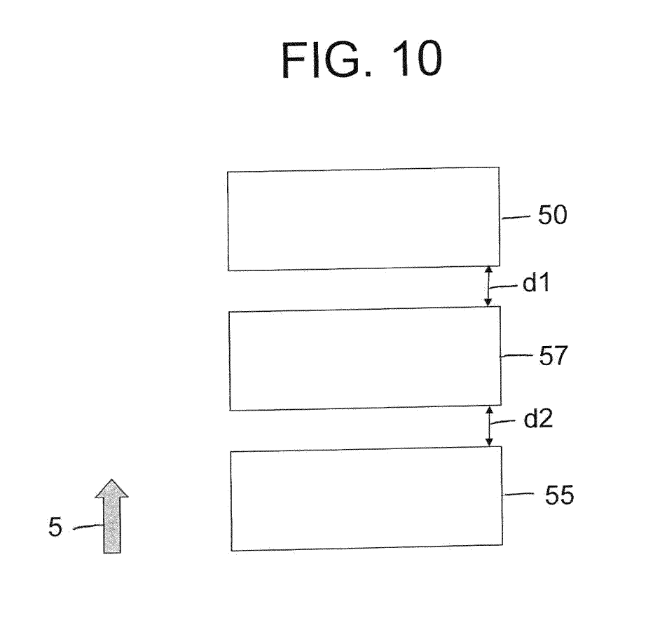

It is to be appreciated that more than two fluoropolymer membranes may form the stacked filter material 20. In one such embodiment depicted generally in FIG. 10, the stacked filter material 20 contains three fluoropolymer membranes 50, 55, and 57. The distance between fluoropolymer membrane 50 and fluoropolymer membrane 57 is designated as d1 and the distance between fluoropolymer membrane 57 and fluoropolymer membrane 55 is designated as d2. It is to be appreciated that d1 and d2 may be the same or different.

In some embodiments, the stacked filter material 20 may contain intervening layers positioned between the fluoropolymer membranes. For example, optional support layers may be located between the fluoropolymer membranes. Non-limiting examples of suitable support layers include polymeric woven materials, non-woven materials, knits, nets, nanofiber materials, and/or porous membranes, including other fluoropolymer membranes (e.g., polytetrafluoroethylene (PTFE). The support layer (not illustrated) may include a plurality of fibers (e.g., fibers, filaments, yarns, etc.) that are formed into a cohesive structure. The support layer is positioned adjacent to and downstream of the stacked filter material to provide support for the stacked filter material and a material for imbibing the fluoropolymer membranes 50, 55. The support layers may be a woven structure, a nonwoven structure, mesh, or a knit structure made using thermoplastic polymeric materials (e.g., polypropylene, polyethylene, or polyester), thermoset polymeric materials (e.g., epoxy, polyurethane or polyimide), or an elastomer. The thickness of the support layers may range from about 1 micron to about 100 microns, from about 1 micron to about 75 microns, or from about 1 micron to about 50 microns, or from about 1 micron to about 25 microns.

In one or more exemplary embodiment, a porous nanofiber membrane formed of a polymeric material and/or phase inversion membranes may be used in place of, or in addition to, the fluoropolymer membranes in the stacked filter material 20. For example, stacked filter material 20 may include a membrane that is formed of, or includes, nanofibers. As used herein, the term “nanofibers” is meant to describe a fiber that has a diameter of a few nanometers up to thousands of nanometers, but not greater than about 1 micron. The diameter of the nanofiber may range from a diameter greater than zero up to about 1000 nm or a diameter greater than zero up to about 100 nm. The nanofibers may be formed of thermoplastic or thermosetting polymers. Additionally, the nanofibers may be electrospun nanofibers. It is to be understood that a porous nanofiber membrane may be positioned at any location within the stacked filter material 20.

The fluoropolymer membranes 50, 55 filter mycoplasma from a fluid stream when the membranes 50, 55 are positioned in the fluid stream. It is to be appreciated that membrane 50 and membrane 55 individually do not meet the requirements for mycoplasma removal of an LRV greater than 8. However, when positioned in a stacked or layered configuration, such as is shown in FIG. 2, the stacked filter material 10 has an LRV greater than 8 and successfully filters mycoplasma.

In one or more exemplary embodiment, at least one of the fluoropolymer membranes is a polytetrafluoroethylene (PTFE) membrane or an expanded polytetrafluoroethylene (ePTFE) membrane. Expanded polytetrafluoroethylene (ePTFE) membranes prepared in accordance with the methods described in U.S. Pat. No. 7,306,729 to Bacino at al., U.S. Pat. No. 3,953,566 to Gore, U.S. Pat. No. 5,476,589 to Bacino, or U.S. Pat. No. 5,183,545 to Branca at at may be used herein.

The fluoropolymer membrane may also include an expanded polymeric material comprising a functional tetrafluoroethylene (TFE) copolymer material having a microstructure characterized by nodes interconnected by fibrils, where the functional TFE copolymer material includes a functional copolymer of TFE and PSVE (perfluorosulfonyl vinyl ether), or TFE with another suitable functional monomer, such as, but not limited to, vinylidene fluoride (VDF). The functional TFE copolymer material may be prepared, for example, according to the methods described in U.S. Patent Publication No. 2010/0248324 to Xu et al. or U.S. Patent Publication No. 2012/035283 to Xu at al. It is to be understood that throughout the application, the term “PTFE” is meant to include not only polytetrafluoroethylene, but also expanded PTFE, expanded modified PTFE, and expanded copolymers of PTFE, such as described in U.S. Pat. No. 5,708,044 to Branca, U.S. Pat. No. 6,541,589 to Baillie, U.S. Pat. No. 7,531,611 to Sabol et al., U.S. Patent Publication No. 2009/0093602 to Ford, and U.S. Patent Publication No. 2010/0248324 to Xu et al.

In one or more exemplary embodiment, the fluoropolymer layer may be substituted with one or more of the following materials: ultra-high molecular weight polyethylene as taught in U.S. Patent Publication No. 2014/0212612 to Sbriglia; polyparaxylylene as taught in U.S. Provisional Application No. 62/030,419 to Sbriglia; polylactic acid as taught in U.S. Provisional Patent Application No. 62/030,408 to Sbriglia, al.; or VDF-co-(TFE or TrFE) polymers as taught in U.S. Provisional Patent Application No. 62/030,442 to Sbriglia.

In addition, the fluoropolymer membrane is thin, having a thickness from about 1 micron to about 15 microns, from about 1 micron to about 10 microns, from about 1 micron to about 7 microns, or from about 1 micron to about 5 microns. Alternatively, the fluoropolymer membrane has a thickness less than about 15 microns, less than about 10 microns, less than about 7 microns, or less than about 5 microns.

The fluoropolymer membranes have a mass/area from about 0.1 g/m² to about 0.5 g/m², from about 0.1 g/m² to about 2 g/m², from about 0.5 g/m² to 1 g/m², from about 1 g/m² to about 15 g/m², from about 1.5 g/m² to about 3 g/m², or from about 3 g/m² to about 5 g/m². Also, the fluoropolymer membranes may have an air permeability from about 0.5 Frazier to about 2 Frazier, or from about 2 Frazier to about 4 Frazier, or from about 4 Frazier to about 6 Frazier, or from about 6 Frazier to about 10 Frazier. Further, the fluoropolymer membrane may be rendered hydrophilic (e.g., water-wettable) using known methods in the art, such as, but not limited to, the method disclosed in U.S. Pat. No. 4,113,912 to Okita, et al.

The bubble point of the fluoropolymer membrane may range from about 30 psi to about 90 psi, from about 35 psi to about 90 psi, from about 50 psi to about 90 psi, from about 50 psi to about 65 psi, or from about 70 psi to about 80 psi.

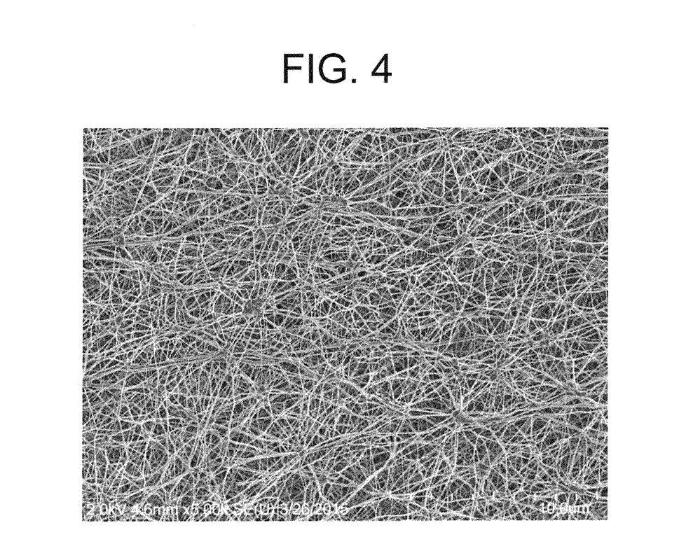

As discussed above, at least one of the fluoropolymer membranes in the stacked filtration member may be an expanded polytetrafluoroethylene (ePTFE) membrane. In a further embodiment, both of the fluoropolymer membranes are ePTFE membranes. The ePTFE membranes may be derived from the same ePTFE membrane, e.g., the two ePTFE membranes may be cut from a larger ePTFE membrane and used in the stacked filtration material. The cut is made orthogonal or substantially orthogonal to the length dimension of the ePTFE membrane, i.e., cut substantially parallel to the thickness dimension. In such an embodiment, the first fluoropolymer membrane 50 and the second fluoropolymer membrane 55 would be the same or nearly the same in measurable properties such as bubble point, thickness, air permeability, mass/area, etc. In such an embodiment, the surface morphology on the surfaces of the ePTFE membranes are the same or substantially the same. Alternatively, the two ePTFE membranes may be derived from separate ePTFE membranes. In this embodiment, the ePTFE membranes 50, 55 would be different. The difference between the two ePTFE membranes may be in pore size, thickness, bubble point, microstructure, or combinations thereof. In addition, the top and bottom surfaces of the ePTFE membranes 50, 55 are free or substantially free of free fibrils. Free fibrils occur in instances where membrane (such as ePTFE) is split, torn, or otherwise fragmented so as to form two membranes from a single parent membrane. The surface of the fluoropolymer membranes 50, 55 may have an appearance such as is shown in FIGS. 4, 5, 7, and 8.

It is to be appreciated that more than two fluoropolymer membranes may form the stacked filter material 20. In addition, the fluoropolymer membranes may be derived from the same fluoropolymer source, from different sources, or a combination thereof. Also, some or all of the fluoropolymer membranes may vary in composition, bubble point, thickness, air permeability, mass/area, etc. from each other.

The fibrous layer in the filtration medium includes a plurality of fibers (e.g., fibers, filaments, yarns, etc.) that are formed into a cohesive structure. The fibrous layer may be positioned adjacent to and upstream and/or downstream of the stacked filter material to provide support for the stacked filter material. The fibrous layer may be a woven structure, a nonwoven structure, or a knit structure, and may be made using polymeric materials such as, but not limited to polypropylene, polyethylene or polyester.

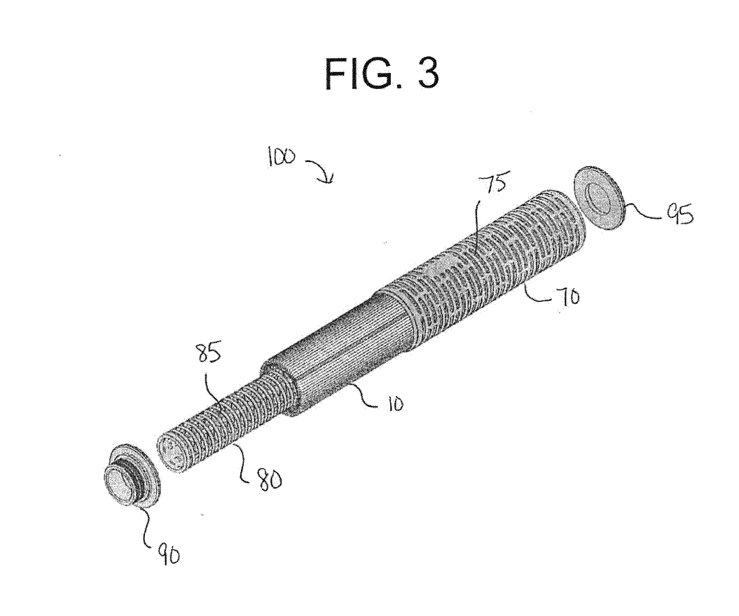

Turning to FIG. 3, the filtration medium 10 may be concentrically disposed within an outer cage 70. The outer cage 70 that has a plurality of apertures 75 through the surface of the outer cage 70 to enable fluid flow through the outer cage 70, e.g., laterally through the surface of the outer cage 70. An inner core member 80 is disposed within the cylindrical filtration medium 10. The inner core member 80 is also substantially cylindrical and includes apertures 85 to permit a fluid stream to flow through the inner core member 80, e.g., laterally through the surface of the inner core member 80. Thus, the filtration medium 10 is disposed between the inner core member 80 and the outer cage 70. The filtration article 100 may be sized for positioning within a filtration capsule (not illustrated).

The filtration device 100 further includes end cap components 90, 95 disposed at opposite ends of the filtration cartridge 100. The end cap components 90, 95 may include apertures (not illustrated) to permit fluid communication with the inner core member 80. Thus, fluid may flow into the filtration cartridge 100 through the apertures and into the inner core member 80. Under sufficient fluid pressure, fluid will pass through apertures 85, through the filtration medium 10, and exit the filtration cartridge 100 through the apertures 75 of the outer cage 70.

When the filtration cartridge 100 is assembled, the end cap components 90, 95 are potted onto the filtration medium 10 with the outer cage 70 and the inner core member 80 disposed between the end cap components 90, 95. The end cap components 90, 95 may be sealed to the filtration medium 10 by heating the end cap components 90, 95 to a temperature that is sufficient to cause the thermoplastic from which the end cap components are fabricated to soften and flow. When the thermoplastic is in a flowable state, the ends of the filtration medium 10 are contacted with the respective end cap components 90, 95 to cause the flowable thermoplastic to imbibe (e.g., to infiltrate) the filtration medium 10. Thereafter, the end cap components 90, 95 are solidified (e.g., by cooling) to form a seal with the filtration medium 10. The assembled filtration cartridge 100 (e.g., with the end cap components potted onto the filtration medium) may then be used in a filtration device such as a filtration capsule. One or both ends of the stacked filtration member 20 and fibrous layers 30, 60 of filtration article 100 may be potted to sealably interconnect the end(s) of the filtration medium 10.

It is to be appreciated that various other configurations of filtration devices may be utilized in accordance with the present disclosure, such as non-cylindrical (e.g., planar) filtration devices. Further, although the flow of fluid is described as being from the outside of the filtration cartridge to the inside of the filtration cartridge (e.g., outside-in flow), it is also contemplated that in some applications fluid flow may occur from the inside of the filtration cartridge to the outside of the filtration cartridge (e.g., inside-out flow).

Persons skilled in the art will readily appreciate that various aspects of the present disclosure can be realized by any number of methods and apparatus configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

### Test Methods

It should be understood that although certain methods and equipment are described below, other methods or equipment determined suitable by one of ordinary skill in the art may be alternatively utilized.

Water Permeability Test Method

A sample membrane was draped across a filter holder. (Sterlitech-540100A; PP 25 In-Line Filter Holder, 25 mm, Polypropylene). The sample membrane was then wet out completely with a mixture of 70% isopropyl alcohol and 30% de-ionized water. The filter holder was then filled with de-ionized water at room temperature. 50 ml of de-ionized water was used to flush residual isopropyl alcohol from the membrane at a pressure of 1.5 psi. A volume of at least 50 ml was then allowed to flow through the membrane at a differential pressure of 1.5 psi across the membrane. The flow rate (ml/see) was measured and recorded. The water permeability was calculated and reported in liter/m²/hr/psi (LMH/psi).

Mycoplasma Retention Test Method

A. Acholeplasma laidlawii ATCC #23206 Challenge Solution Preparation

A challenge solution of Acholeplasma laidlawii ATCC #23206 was prepared from a stock culture vial stored in a −70° C. freezer. Acholeplasma laidlawii ATCC #23206 in the stock vial was thawed and transferred into test jars, each containing 100 ml of sterile Trypticase Soy Broth (TSB) broth. The test jars were placed in an incubator having a set point of about 37° C. for 48 hours. After 48 hours the jars were removed and the contents of the test jars were transferred into one larger jar. Sterile phosphate buffer solution was then added to the larger jar to obtain a final concentration of the challenge solution of at least 10⁷ CFU/cm². Hemocytometer counts were performed to confirm the final challenge solution concentration.

B. Filtration Test Procedure

A 47 mm disk of a polypropylene non-woven material was placed on top of the metal screen of a filter holder (Part No. DH1-047-10-S, Meissner Filter Products, Camarillo, Calif.). A first ePTFE membrane having a Bubble Point less than 3 psi was placed on top of the non-woven material as a support layer. The testing membrane or membrane stack, for example a second ePTFE membrane or membrane stack prepared in accordance with an ePTFE membrane made in accordance with Example 1, was placed on top of the first ePTFE membrane without wrinkling. The filter holder was then tightened with clamps. P′VDF hydrophilic membranes with a rated pore size of 0.22 micron (Part Number GVWP04700, Millipore, Billerica, Mass.) and 0.1 micron (Part Number WLP04700 Millipore, Billerica, Mass.) were used as the size control membranes as part of the test procedure.

Three pressurized vessels were loaded with the Acholeplasma laidlawii ATCC #23206 challenge solution, sterilized phosphate buffer rinse, and IPA (70%), respectively. Transfer lines, air tubes, valves, and calibrated gas gauges were connected to the vessels aseptically. The pressure was set at 30 psig throughout the test system. All three transfer lines out of the three pressurized vessels were primed by means of controlling valves. The filter holder was connected to the Acholeplasma laidlawii ATCC #23206 challenge solution vessel.

When hydrophobic ePTFE membranes were tested, the membranes were pre-wetted with 300 ml of 70% IPA followed by a 600 ml sterile phosphate buffer rinse. At a differential pressure of 30 psid across the hydrophobic ePTFE membranes, the Acholeptasma laidlawii ATCC #23206 challenge solution was filtered through the hydrophobic ePTFE membranes.

About 160 ml of the filtrate was collected in a 500 ml sterile sample bottle and subsequently passed under vacuum through an assay filter (0.22 μm rated pore size, Part No. GVWP4700 from Millipore, Billerica, Mass.) housed in a filter assembly. The assay filter was then removed from the assembly and placed on SP4 plates. These plates were then incubated at 37° C. with 5% CO₂ for 5 days to grow the Acholeplasma laidlawii colonies. After incubation, the assay filter was stained with a 1:10 dilution of Dienes stain (Remel Part No. R40017) and observed under a dissecting scope. The Acholeplasma laidlawii colonies were counted as colony forming units (CFU) and recorded.

The filtration efficiency was denoted by the log reduction value (LRV) and was determined by the following equation: LRV=Log (Acholeplasma laidlawii counts in the challenge solution)−Log (Acholeplasma laidlawii counts in the filtrate).

Bubble Point

The bubble point was measured according to the general teachings of ASTM F31 6-03 using a Capillary Flow Porometer (Model CFP 1500 AE from Porous Materials, Inc., Ithaca, N.Y.). The sample membrane was placed into a sample chamber and wet with SilWick Silicone Fluid (commercially available from Porous Materials, Inc.) having a surface tension of 19.1 dynes/cm. The bottom clamp of the sample chamber consists of a 40 micron porous metal disc insert (Mott Metallurgical, Farmington, Conn.) with the following dimensions (2.54 cm diameter, 3.175 mm thickness). The top clamp of the sample chamber consists of an opening, 12.7 mm in diameter. Using the Capwin software version 6.74.70, the following parameters were set as specified in Table 1. The values presented for bubble point were the average of two measurements.

TABLE 1

| Parameter Set Point | Set Point |
|---|---|
| Maxflow (cc/m) | 200000 |
| Bubflow (cc/m) | 38 |
| F/PT | 50 |
| Minbppres (psi) | 0.1 |
| Zerotime (sec) | 1 |
| V2incr (cts) | 10 |
| Preginc (cts) | 1 |
| Pulse Delay (sec) | 2 |
| Maxpress (psi) | 500 |
| Pulse Width (sec) | 0.2 |
| Mineqtime (sec) | 30 |
| Presslew (cts) | 10 |
| Flowslew (cts) | 50 |
| Eqiter (0.1 sec) | 3 |
| Aveiter (0.1 sec) | 20 |
| Maxpdif (psi) | 0.1 |
| Maxfdif (cc/m) | 50 |
| Startp (psi) | 1 |

Mass Per Area (Mass/Area)

The mass/area of the membrane was calculated by measuring the mass of a well-defined area of the sample using a scale. The sample was cut to a defined area using a die or any precise cutting instrument.

Frazier Air Permeability

Air flow was measured using the TexTest Model FX3310 instrument. The air flow rate through the sample was measured and recorded. The Frazier Air Permeability is the rate of flow of air in cubic feet per square foot of sample area per minute when the differential pressure drop across the sample is 12.7 mm (0.5 inch) water column.

Membrane Thickness Using Scanning Electron Micrograph (SEM)

Membranes were sectioned using a cold single-sided razor blade. The sections were mounted on an aluminum SEM stub with conductive double-sided carbon tape. Sections were approximately 5 mm in length. Images were acquired at magnifications of 5000× and 10,000×, a working distance of 3-5 mm, and an operating voltage of 2 kV on a Hitachi(r) SU-8000 Field Emission Scanning Electron Microscope (FE-SEM). Images were recorded at a data size of 2560×1920. Point-to-point thickness measurements of features of interest on the images were measured and recorded using Quartz Imaging(r) PCI software. The MRS-4 calibration standard (Geller MicroAnalytical Laboratory) was to calibrate the FESEM.

### EXAMPLES

### Example

A fine powder of polytetrafluoroethylene (PTFE) polymer (DuPont, Parkersbury, W. Va.) was blended with Isopar™ K (Exxon Mobil Corp., Fairfax, Va.) in the proportion of Isopar™ K to fine powder of 0.218 g/g. The lubricated powder was compressed in a cylinder to form a pellet and placed into an oven set at 49° C. The compressed pellet was ram extruded to produce a tape approximately 16.0 cm wide by 0.68 mm thick. The tape was then passed through a set of compression rolls to a thickness of 0.25 mm. The tape was then transversely stretched to approximately 62 cm (i.e., at a ratio of 5.4:1), restrained, then dried in an oven set at 250° C. The dry tape was longitudinally expanded between banks of rolls over a heated plate set to a temperature of 315° C. at an expansion ratio of 12:1. The longitudinally expanded tape was then expanded transversely at an approximate temperature of 350° C. and at a transverse expansion ratio of 18.2:1. The expanded PTFE membrane was then constrained and heated in an oven set to 350° C. for approximately 8 seconds.

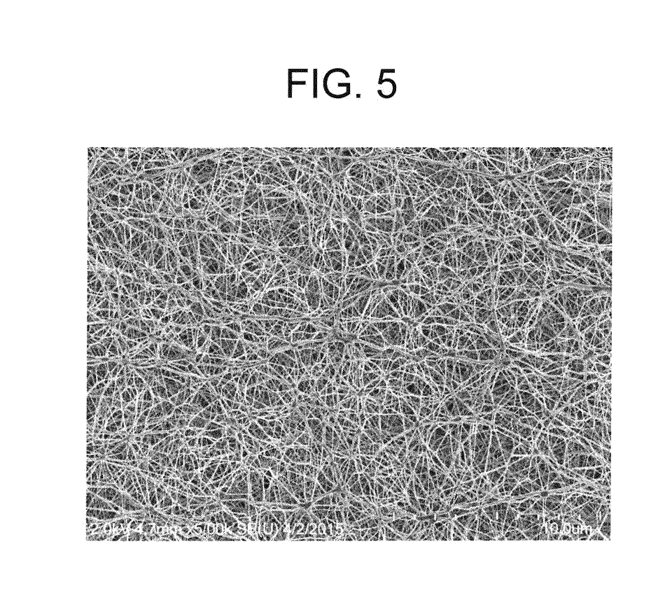

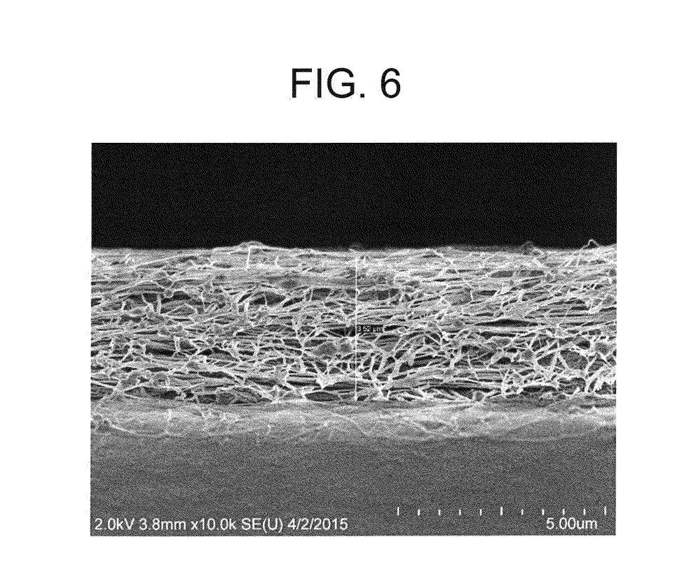

FIG. 4 is a scanning electron micrograph (SEM) of the top surface of the resulting ePTFE membrane taken at 5000×. FIG. 5 is an SEM of the bottom surface of the same ePTFE membrane taken at 5000×. FIG. 6 is an SEM of the cross section of the ePTFE membrane taken at 10,000×. The thickness of the ePTFE membrane was determined to be 3.5 microns based on the cross-section SEM of the ePTFE membrane (FIG. 6). As shown in Table 2, the resulting ePTFE membrane had a Bubble Point of 43.4 psi, air permeability of 3.2 Frazier, water permeability of 8100 LMH/psi, and mass per area of 1.04 g/m².

Two of these ePTFE membranes were placed on top of each other in a layered or stacked configuration to form a two-layered stacked filter. The stacked filter had an increased Bubble Point of 52.0 psi. The air and water permeability of the stacked filter was measured to be 1.5 Frazier and 4100 LHM/psi, respectively. The two-layered stacked filter was tested in accordance with the Mycoplasma Retention Test Method set forth herein. The average Log Reduction Value (LRV) of the two layered stacked filter was determined to be 8.5.

### Example 2

A fine powder of polytetrafluoroethylene (PTFE) polymer (DuPont., Parkersbury, W. Va.) was blended with Isopar™ K (Exxon Mobil Corp., Fairfax. Va.) in the proportion of Isopar™ K to fine powder of 0.168 g/g. The lubricated powder was compressed in a cylinder to form a pellet and placed into an oven set at 49° C. The compressed pellet was ram extruded to produce a tape approximately 16.0 cm wide by 0.70 mm thick. The tape was then passed through a set of compression rolls to a thickness of 0.25 mm. The tape was then transversely stretched to approximately 62 cm (i.e. at a ratio of 5.4:1), restrained, then dried in an oven set at 250 The dry tape was longitudinally expanded between banks of rolls over a heated plate set to a temperature of 315° C. at an expansion ratio of 12:1. The longitudinally expanded tape was then expanded transversely at an approximate temperature of 320° C. and at a transverse expansion ratio of 12.4:1. The expanded PTFE was then and constrained and heated in an oven set at a temperature of 320° C. for approximately 8 seconds.

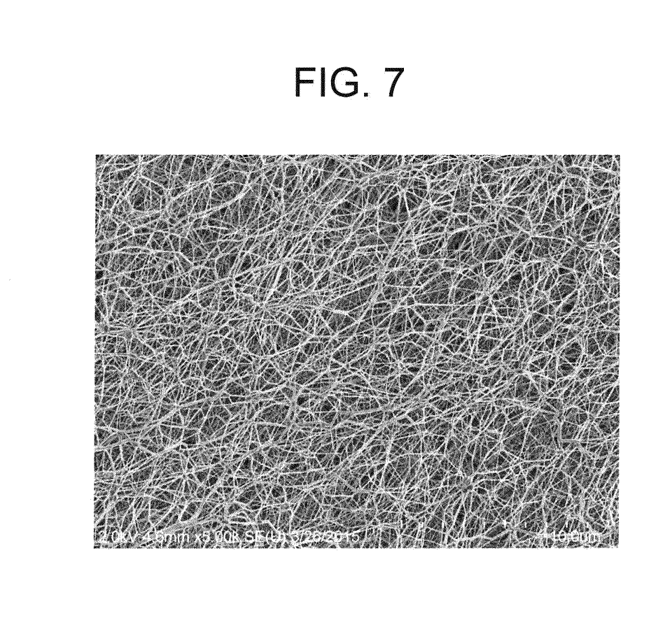

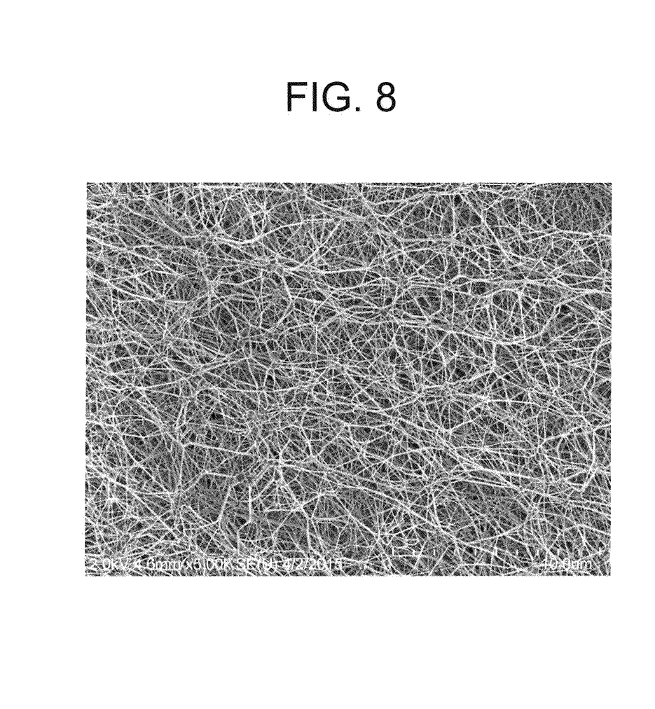

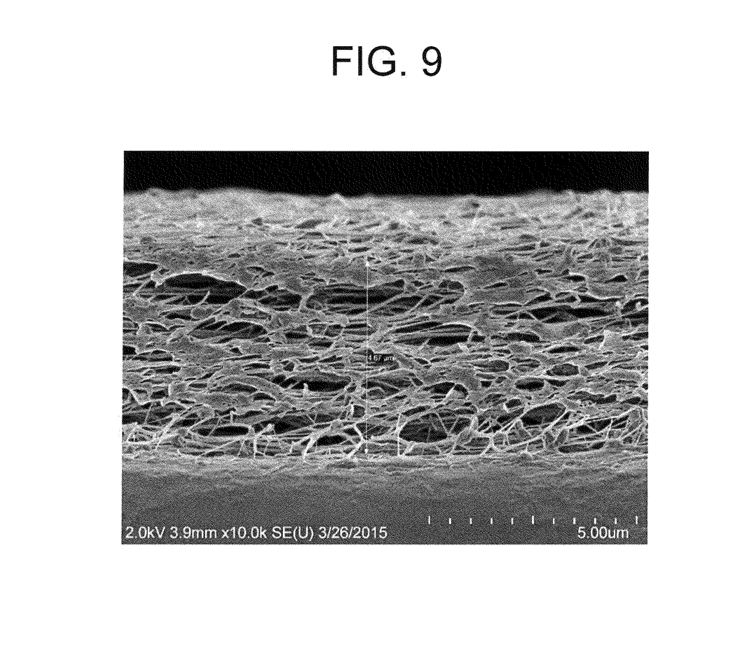

FIG. 7 is a scanning electron micrograph (SEM) of the top surface of the resulting ePTFE membrane taken at 5000×. FIG. 8 is an SEM of the bottom surface of the same ePTFE membrane taken at 5000×. FIG. 9 is an SEM of the cross section of the ePTFE membrane taken at 10,000×. The thickness of the ePTFE membrane was determined to be 4.7 microns based on the cross-section SEM of the ePTFE membrane (FIG. 9).

As shown in Table 2, the resulting ePTFE membrane had a Bubble Point of 52.8 psi, air permeability of 2.2 Frazier, water permeability of 5800 LMH/psi, and mass per area of 1.21 g/m².

Two of these ePTFE membranes were placed on top of each other in a layered or stacked configuration to form a two-layered stacked filter. The stacked filter had an increased Bubble Point of 64.8 psi. The air and water permeability of the stacked filter was measured to be 1.1 Frazier and 3300 LHM/psi, respectively. The two-layered stacked filter was tested in accordance with the Mycoplasma Retention Test Method set forth herein. The Log Reduction Value (LRV) of the two layered stacked filter was determined to be 8.7.

### Comparative Example

A single layer of the ePTFE membrane from Example 1 was tested in accordance with the Mycoplasma Retention Test Method set forth herein. The average LRV of the single layer ePTFE membrane was determined to be 6.3. The results are set forth in Table 2.

### Comparative Example 2

A single layer of expanded PTFE membrane from Example 1 was tested in accordance with the Mycoplasma Retention Test Method set forth herein. The average LRV of the single layer ePTFE membrane was determined to be 7.1. The results are set forth in Table 2.

TABLE 2

| | Bubble | | | | Water | Log |
|---|---|---|---|---|---|---|
| | Point | Mass/Area | Thickness | | Permeability | Reduction Value* |
| | (psi) | (g/m²) | (micron) | Frazier | (LMH/psi) | (LRV) |
| Example 1 | 43.4, | 1.04 | 3.5 | 1.5** | 4100** | 8.5** |
| | 52.0** | | | | | |
| Example 2 | 52.8, | 1.21 | 4.7 | 1.1** | 3300** | 8.7** |
| | 64.8** | | | | | |
| Comparative | 43.4 | 1.04 | 3.5 | 3.2 | 8100 | 6.3 |
| Example 1 | | | | | | |
| Comparative | 52.8 | 1.21 | 4.7 | 2.2 | 5800 | 7.1 |
| Example 2 | | | | | | |
| 0.22 μm | | | | | 640 | 4.7 |
| PVDF | | | | | | |
| control | | | | | | |
| 0.1 μm | | | | | 190 | 8.2 |
| PVDF | | | | | | |
| control | | | | | | |

*per Mycoplasma Retention Test Method set forth herein
**indicates 2 layer stacked filter measurements

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

What is claimed is:

1. A stacked bacterial filter material comprising:
a first mycoplasma non-retentive fluoropolymer membrane having a first major surface and a second major surface; and
a second mycoplasma non-retentive fluoropolymer membrane positioned on one of said first major surface and second major surface a first distance from said first fluoropolymer membrane,
wherein said distance is less than 100 microns,
wherein said first and second major surfaces are substantially free of fibrils,
wherein said first and second fluoropolymer membranes each have a bubble point from about 30 psi to about 90 psi,
wherein said first and second fluoropolymer membranes each have a thickness less than about 10 microns, and
wherein said stacked bacterial filtration material is mycoplasma retentive.

2. The stacked bacterial filter material of claim 1, wherein said stacked bacterial filtration material has a Log Retention Value greater than 8.

3. The stacked bacterial filter material of claim 1, wherein said first and second fluoropolymer membranes each have a mass/area from about 0.1 g/m² to about 2 g/m².

4. The stacked bacterial filter material of claim 1, wherein at least one of said first and second fluoropolymer membranes is an expanded polytetrafluoroethylene membrane.

5. The stacked bacterial filter material of claim 1, wherein said first and second fluoropolymer membranes are derived from a parent fluoropolymer membrane divided in a direction perpendicular to a length direction of said parent fluoropolymer membrane.

6. The stacked bacterial filter material of claim 1, wherein said at least one of said first mycoplasma non-retentive fluoropolymer membrane and said second mycoplasma non-retentive fluoropolymer membrane is rendered hydrophilic.

7. The stacked bacterial filter material of claim 1, wherein said first and second fluoropolymer membranes are laminated to each other.

8. The stacked bacterial filter material of claim 1, wherein said first and second fluoropolymer membranes form a composite stacked filtration material.

9. The stacked bacterial filter material of claim 8, wherein composite stacked filtration material has a bubble point from about 30 psi to about 90 psi.

10. The stacked bacterial filter material of claim 1, further comprising a third mycoplasma non-retentive fluoropolymer membrane having a first major surface and a second major surface,
wherein said first mycoplasma non-retentive fluoropolymer membrane, said second mycoplasma non-retentive fluoropolymer membrane, and said third mycoplasma non-retentive fluoropolymer membrane are positioned a distance each other, said distance being less than 100 microns.

11. The stacked bacterial filter material of claim 1, wherein said first and second fluoropolymer membranes each have a bubble point from about 50 psi to about 90 psi.

12. The stacked bacterial filter material of claim 1, wherein at least one of said first and second fluoropolymer membranes includes nanofibers therein.

13. The stacked bacterial filter material of claim 1, further comprising a nanofiber membrane.

14. A bacterial filtration material comprising:
a stacked filter material comprising:
a first mycoplasma non-retentive fluoropolymer membrane having a first major surface and a second major surface; and
a second mycoplasma non-retentive fluoropolymer membrane positioned on said first major surface a distance from said first major surface, and
a first fibrous layer positioned on said stacked filter material,
wherein said distance is less than 100 microns,
wherein at least one of said first and second fluoropolymer membranes are derived from a parent fluoropolymer membrane divided in a direction perpendicular to a length direction of said parent fluoropolymer membrane,
wherein said first and second fluoropolymer membranes each have a bubble point from about 30 psi to about 90 psi,
wherein said first and second fluoropolymer membranes each have a thickness less than about 10 microns, and
wherein said stacked bacterial filtration material is mycoplasma retentive.

15. The bacterial filtration material of claim 14, wherein said stacked bacterial filtration material has a Log Retention Value greater than 8.

16. The bacterial filtration material of claim 14, wherein said first and second fluoropolymer membranes are derived from a parent fluoropolymer membrane divided in a direction perpendicular to a length direction of said parent fluoropolymer membrane

17. The bacterial filtration material of claim 14, further comprising a second fibrous layer positioned on said stacked filter material on a side opposing said first fibrous layer.

18. The bacterial filtration material of claim 14, wherein said first and second fluoropolymer membranes each have a bubble point from about 50 psi to about 90 psi.

19. The bacterial filter material of claim 14, wherein said first and second fluoropolymer membranes each have a mass/area from about 0.1 g/m² to about 2 g/m².

20. The bacterial filter material of claim 14, wherein at least one of said first and second fluoropolymer membranes is an expanded polytetrafluoroethylene membrane.

21. The bacterial filter material of claim 14, wherein said distance is substantially zero microns.

22. The bacterial filter material of claim 14, wherein said first and second fluoropolymer membranes are laminated to each other.

23. The bacterial filter material of claim 14, wherein said first and second fluoropolymer membranes form a composite stacked filtration material.

24. The bacterial filter material of claim 14, wherein said bacterial filtration material has a bubble point from about 30 psi to about 90 psi.

25. The bacterial filter material of claim 14, wherein said at least one of said first mycoplasma non-retentive fluoropolymer membrane and said second mycoplasma non-retentive fluoropolymer membrane is rendered hydrophilic.

26. A stacked bacterial filter material comprising:
a stacked filtration material comprising a first mycoplasma non-retentive fluoropolymer membrane and a second mycoplasma non-retentive fluoropolymer membrane, said stacked filtration material having a first major surface and a second major surface,
wherein said first and second fluoropolymer membranes are positioned a distance less than 100 microns from each other,
wherein said first and second major surfaces are substantially free of free fibrils,
wherein said stacked filtration material has a bubble point from about 30 psi to about 90 psi, and
wherein said first and second fluoropolymer membranes each have a thickness less than about 10 microns, and
wherein said stacked bacterial filtration material is mycoplasma retentive.

27. The stacked bacterial filter material of claim 26, wherein said stacked bacterial filtration material has a Log Retention Value greater than 8.

28. The stacked bacterial filter material of claim 26, wherein said first and second fluoropolymer membranes are co-extruded to form said stacked filtration material.

29. The stacked bacterial filter material of claim 26, wherein said first and second fluoropolymer membranes are laminated to form said stacked filtration material.

30. The stacked bacterial filter material of claim 26, wherein said at least one of said first mycoplasma non-retentive fluoropolymer membrane and said second mycoplasma non-retentive fluoropolymer membrane is rendered hydrophilic.

31. The stacked bacterial filter material of claim 26, wherein said first and second fluoropolymer membranes each have a mass/area from about 0.1 g/m² to about 2 g/m².

32. The stacked bacterial filter material of claim 26, wherein said first and second fluoropolymer membranes are co-expanded to form said stacked filtration material.

33. A stacked bacterial filter material comprising:
a first mycoplasma non-retentive nanofiber membrane having a first major surface and a second major surface; and
a second mycoplasma non-retentive nanofiber membrane positioned on one of said first major surface and second major surface a first distance from said first fluoropolymer membrane,
wherein said distance is less than 100 microns,
wherein said stacked bacterial filtration material is mycoplasma retentive.

34. The stacked bacterial filter material of claim 33, wherein said stacked bacterial filtration material has a Log Retention Value greater than 8.
